(19) United States
(12) Patent Application Publication
(10) Pub. No.: US 2010/0263303 A1
(43) Pub. Date: Oct. 21, 2010

(54) PEST BLOCKING DEVICE

(76) Inventor: Boaz Kiserman, Tel Aviv (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 12/746,794

(22) PCT Filed: Dec. 10, 2008
(86) PCT No.: PCT/IL08/01602

§ 371 Date: Jun. 8, 2010

(30) Foreign Application Priority Data
Dec. 12, 2007 (IL) 188083

(51) Int. Cl. E04B 1/72

(52) U.S. Cl. 52/101; 52/173.1

(57) ABSTRACT

A pest blocking device including a row of bendable members extending from a base member, wherein at least one of the bendable members is bent with respect to the base member, and wherein the base member is formed to fit in a given passageway and defines an aperture for passing articles therethrough into the passageway and the bendable members are bent to block a pest from entering the passageway.

### FIELD OF THE INVENTION

The present invention relates generally to devices for blocking entry of pests into passageways and the like.

### BACKGROUND OF THE INVENTION

Rodents, birds and other animals (herein called pests) can gain access into air conditioner ducts, electrical wiring conduits and the like. Such pests can cause major damage to equipment with great financial losses. Various devices and gimmicks have been proposed and used throughout the years to prevent pests from entering such places, such as steel wool used to stuff openings that pests could get through. However, the need still exists for a better solution.

### SUMMARY OF THE INVENTION

The present invention seeks to provide improved devices for blocking entry of pests into passageways and the like, as described more in detail hereinbelow.

There is provided in accordance with an embodiment of the present invention a pest blocking device including a row of bendable members extending from a base member, wherein at least one of the bendable members is bent with respect to the base member, and wherein the base member is formed to fit in a given passageway and defines an aperture for passing articles therethrough into the passageway and the bendable members are bent to block a pest from entering the passageway.

In accordance with an embodiment of the present invention, the bendable members are bent generally perpendicularly with respect to the base member.

In accordance with an embodiment of the present invention, the bendable members and the base member are bent into a circle or ellipse.

In accordance with an embodiment of the present invention, the base member has grooves formed therein at ends thereof.

In accordance with an embodiment of the present invention, a fastener secures the pest blocking device in a desired bent shape. The fastener may include hooked ends that fit into the grooves. A plurality of the pest blocking devices may be nested inside each other.

In accordance with an embodiment of the present invention, additional blocking elements are provided that include strips and connectors.

### BRIEF DESCRIPTION OF THE DRAWINGS

The present invention will be understood and appreciated more fully from the following detailed description taken in conjunction with the drawings in which:

FIGS. 1 and 2 are simplified pictorial illustrations of a pest blocking device, constructed and operative in accordance with an embodiment of the present invention, respectively before and after forming into a blocker against pests;

FIG. 3 is a simplified pictorial illustration of additional blocking elements useful with the device of FIG. 1, in accordance with an embodiment of the present invention;

FIGS. 4A and 4B are simplified pictorial illustrations of additional blocking elements assembled with the device of FIG. 1, in accordance with embodiments of the present invention;

FIGS. 5A and 5B are respective simplified pictorial illustrations of a prior art electrical box and an electrical box constructed and operative in accordance with an embodiment of the present invention, the box of FIG. 5B being equipped with the pest blocking device of FIGS. 1 and 2; and

FIGS. 6A-6D are simplified pictorial illustrations of a pest blocking device, constructed and operative in accordance with another embodiment of the present invention.

### DETAILED DESCRIPTION OF EMBODIMENTS

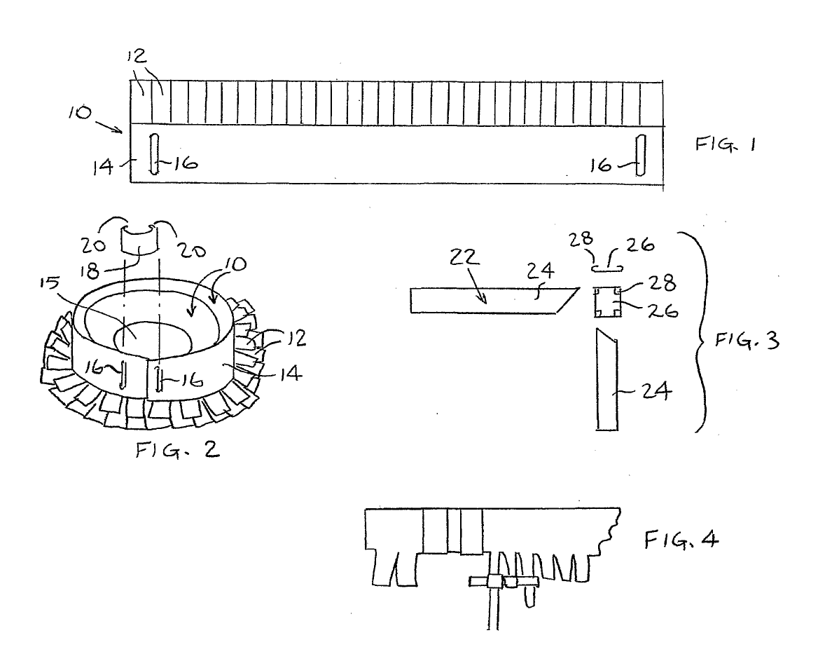

Reference is now made to FIGS. 1 and 2, which illustrate a pest blocking device 10, constructed and operative in accordance with an embodiment of the present invention.

Pest blocking device 10 includes a row of bendable members 12 extending from a base member 14, and is preferably fashioned from sheet metal and the like. Base member 14 has grooves 16 formed therein at ends thereof.

As seen in FIG. 2, pest blocking device 10 may be bent or otherwise formed to a configuration suitable for blocking pests from entering air conditioner ducts, electrical wiring conduits and the like. In the illustrated embodiment, pest blocking device 10 is formed by bending one or more bendable members 12 generally perpendicularly with respect to base member 14 and curling the bendable members 12 and base member 14 into a circle or ellipse. A fastener 18, such as a curved sheet metal strip with hooked ends 20, may be used to secure the bent pest blocking device 10 and keep it in place. The hooked ends 20 fit into grooves 16. As seen in FIG. 2, a plurality of pest blocking devices 10 may be nested inside each other. The pest blocking devices 10 may be bent and otherwise formed into a variety of shapes, curled and not curled, straight and not straight.

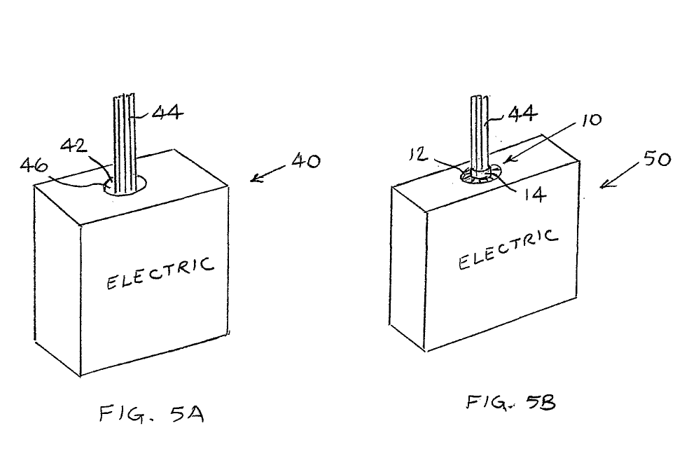

The base member 14 is formed to fit in a given passageway (not shown in FIG. 2, but shown in FIGS. 5A and 5B) and defines an aperture 15 for passing articles (e.g., electrical wiring, air conditioning tubes, etc.) therethrough into the passageway. The bendable members 12 are bent to block a pest from entering the passageway. The pest blocking device 10 does not have to be formed ahead of time and can easily be formed on site. The pest blocking device 10 can be formed into any desired shape for fitting between pipes or other nooks and crannies. The pest blocking device 10 can easily be dismantled, unlike prior art devices, such as steel wool, which must be bonded or otherwise fastened in place and are difficult to dismantle.

Reference is now made to FIGS. 3 and 4A, which illustrate additional blocking elements 22 useful with pest blocking device 10, in accordance with an embodiment of the present invention. The additional blocking elements 22 may include strips 24 and connectors 26. The connectors 26 have bent tabs 28 that allow slipping over and connecting with bendable members 12 and other blocking elements 22. In this manner, any number of blocking elements 22 can be added as necessary in any shape or direction.

Reference is now made to FIG. 4B, which illustrates additional blocking elements 60 useful with pest blocking device 10, in accordance with an embodiment of the present invention.

Reference is now made to FIGS. 5A and 5B. FIG. 5A illustrates a prior art electrical box 40, which has a passageway 42 for passing electrical wires or cables 44 therethrough. The wires 44 do not fill the entire cross-sectional area of passageway 42 and gaps 46 exist through which pests can enter. FIG. 5B illustrates an electrical box 50 constructed and operative in accordance with an embodiment of the present invention. Box 50 is equipped with the pest blocking device 10 of FIGS. 1 and 2. The bendable members 12 block pests from entering box 50 and base member 14 defines an aperture for passing wires 44 therethrough.

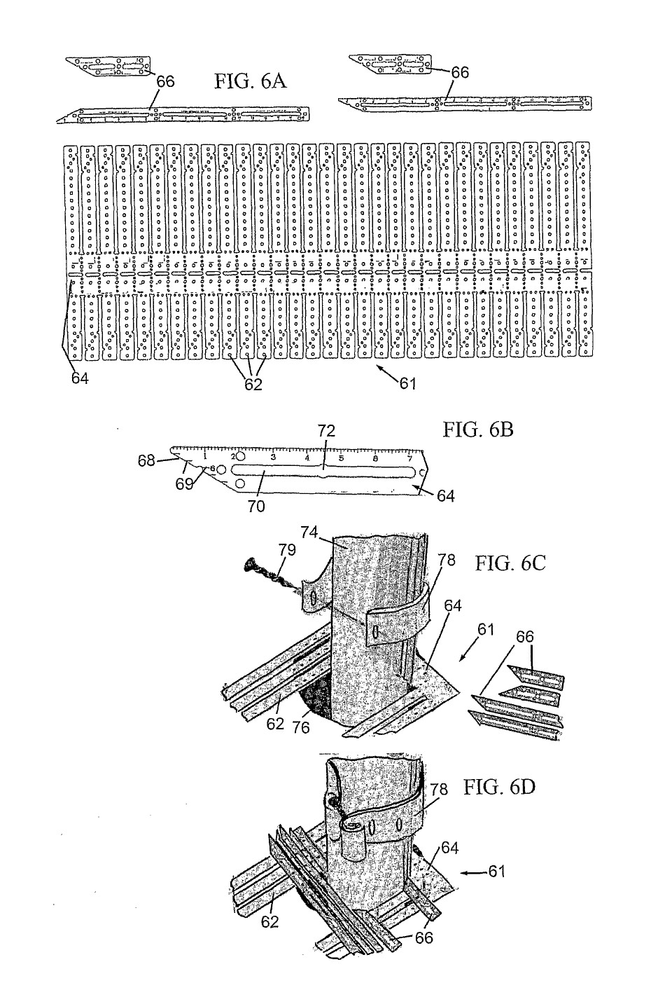

Reference is now made to FIGS. 6A-6D, which illustrate a pest blocking device 61, constructed and operative in accordance with another embodiment of the present invention.

Pest blocking device 61, similar to the other embodiments of the invention, includes a row of bendable members 62 extending from a base member 64, and is preferably fashioned from sheet metal and the like. The bendable members 62 may not only be bent from base member 64 but may also be broken off base member 64. Here, too, additional blocking elements are provided, such as but not limited to, strips 66. Pest blocking device 61 may be manufactured and made available in a kit that includes all the elements, devices and mechanical fasteners needed by an installer to install the pest blockers. Bendable members 62 and base member 64 may be formed with all sorts of mounting holes and other mounting features.

Referring particularly to FIG. 6B, strip 66 may be provided with certain features that help the installer. For example, strip 66 may be provided with ruler markings to measure sizes of openings to determine if they need to be blocked and with what elements of the kit to block them. Furthermore, strip 66 may be formed with a diagonal edge 68 with ruled markings 69 along diagonal edge 68. The diagonal edge 68 may be inserted in a hole and the like to determine the hole's diameter, which is read at the ruled markings 69. Strip 66 may also be formed with an elongate aperture 70 with an enlarged hole 72. A screw may be fitted through enlarged hole 72 and then placed anywhere along elongate aperture 70 for fastening strip 66 to another element, such as bendable members 62, base member 64 or other structures.

FIG. 6C illustrates placing base member 64 around a pipe 74 that passes through a hole 76 (such as in a floor, wall or ceiling). Some of the bendable members 62 have been broken off base member 64 so the device fits around pipe 74. An additional base member 64 may be secured to pipe 74 vertically, such as by means of a band 78 that tightens against the additional base member 64 by means of a screw 79 that squeezes the ends of band 78 toward each other.

In FIG. 6D strips 66 have been placed over the remaining open part of hole 76 and secured to base member 64 with screws or other mechanical fasteners. No pest can now get pest device 61 along pipe 74.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

1. A pest blocking device comprising:
a row of bendable members extending from a base member, wherein at least one of said bendable members is bent with respect to said base member, and wherein said base member is formed to fit in a given passageway and defines an aperture for passing articles therethrough into said passageway and said bendable members are bent to block a pest from entering said passageway, wherein at least one of said bendable members is bent generally perpendicularly with respect to said base member and wherein at least one of said bendable members is bent into a circle or ellipse.

2-3. (canceled)

4. The pest blocking device according to claim 1, wherein said base member has grooves formed therein at ends thereof.

5. The pest blocking device according to claim 1, further comprising a fastener that secures said pest blocking device in a desired bent shape.

6. The pest blocking device according to claim 4, further comprising a fastener that secures said pest blocking device in a desired bent shape, wherein said fastener comprises hooked ends that fit into said grooves.

7. A pest blocking device comprising:
a row of bendable members extending from a base member, wherein at least one of said bendable members is bent with respect to said base member, and wherein said base member is formed to fit in a given passageway and defines an aperture for passing articles therethrough into said passageway and said bendable members are bent to block a pest from entering said passageway, and further comprising a plurality of the pest blocking devices nested inside each other.

8. The pest blocking device according to claim 1, further comprising additional blocking elements that comprise strips and connectors.

9. Apparatus comprising:
an electrical box formed with a passageway for passing electrical wires therethrough; and
a pest blocking device fitted in said passageway, said pest blocking device comprising a row of bendable members extending from a base member, wherein at least one of said bendable members is bent with respect to said base member, and wherein said base member is formed to fit in said passageway and defines an aperture for passing articles therethrough into said passageway and said bendable members are bent to block a pest from entering said passageway, and further comprising a plurality of the pest blocking devices nested inside each other.
